(19) United States
(12) Patent Application Publication
(10) Pub. No.: US 2018/0246797 A1
(43) Pub. Date: Aug. 30, 2018

(54) IDENTIFYING AND MONITORING NORMAL USER AND USER GROUP INTERACTIONS

(71) Applicants: Ankur MODI, London (GB); Mircea DÃNILÃ-DUMITRESCU, London (GB)

(72) Inventors: Ankur MODI, London (GB); Mircea DÃNILÃ-DUMITRESCU, London (GB)

(21) Appl. No.: 15/756,069

(22) PCT Filed: Aug. 30, 2016
(86) PCT No.: PCT/GB2016/052684

§ 371 Date: Feb. 28, 2018

(30) Foreign Application Priority Data
Aug. 28, 2015 (GB) 1515384.4

(51) Int. Cl. G06F 11/34; G06Q 10/06; G06F 11/30; G06N 3/08; G06N 7/00; G06F 17/30

(52) U.S. Cl. CPC G06F 11/3438; G06Q 10/06398; G06F 17/30312; G06N 3/08; G06N 7/005; G06F 11/3024

(57) ABSTRACT

The invention relates to a network monitoring system for computer systems. According to an aspect of the invention, there is provided a method for monitoring user interactions within one or more monitored computer systems, comprising the steps of: receiving metadata from one or more devices within the one or more monitored computer systems; identifying from the metadata events corresponding to a plurality of user interactions with the monitored computer systems; storing user interaction event data from the identified said events corresponding to a plurality of user interactions with the monitored computer systems; determining, using the stored user interaction event data, normal user interaction behaviour; and storing the determined normal user interaction behaviour as a reference.

### FIELD OF THE INVENTION

The invention relates to a monitoring system for a computer system.

### BACKGROUND

It is useful for organisations to monitor the behaviour and/or performance of users of computer systems, so as to identify where efforts for performance improvement should be focussed. However, known monitoring solutions collect either a limited amount of information, or too much information that cannot be effectively analysed. The size and complexity of many organisations' systems makes effective monitoring within a system very difficult. Privacy and confidentiality concerns may also increase the difficulty in effectively monitoring the activity occurring in such computer systems.

The present invention seeks at least to alleviate partially at least some of the above problems.

### SUMMARY OF INVENTION

Aspects and embodiments are set out in the appended claims. These and other aspects and embodiments are also described herein.

According to a first aspect, there is provided a method for monitoring user interactions within one or more monitored computer systems, comprising the steps of: receiving metadata from one or more devices within the one or more monitored computer systems; identifying from the metadata events corresponding to a plurality of user interactions with the monitored computer systems; storing user interaction event data from the identified said events corresponding to a plurality of user interactions with the monitored computer systems; determining, using the stored user interaction event data, normal user interaction behaviour; and storing the determined normal user interaction behaviour as a reference.

By collecting event data obtained from metadata in order to determine the normal behaviour of users, a non-intrusive means of monitoring can be provided. Metadata from different sources may be pooled to enable effective and wide-reaching evaluation. The use of metadata related to user interactions (as encapsulated in log files, for example, which are typically already generated by devices and/or applications) means that data related to human interaction events can be obtained without needing to provide means to inspect and/or monitor the substantive content of user interactions with the system or data flowing within the system, which may be intrusive and difficult to set-up due to the volume of data that would then need to be processed. The term ‘metadata’ as used herein can refer to log data and/or log metadata.

Optionally, the method further comprises the step of comparing user interaction event data against the reference to evaluate user interactions.

Comparing user interactions against the determined normal behaviour can lead to effective monitoring of users and allow abnormalities to be identified.

Optionally, a sequence of user interaction events is identified and compared against said reference where the reference is a sequence of events.

By comparing sequences of events, more meaningful evaluation can be enabled.

Optionally, the time between user interaction events in the sequence is compared against the time between events in the reference sequence.

By comparing the times between events in sequences, particularly meaningful evaluation can be enabled.

Optionally, the reference is reference user interaction event data. By using user interaction event data as the reference the comparison between different groups can be enabled.

Optionally, the user interaction event data relates to a first common parameter and the reference is a second plurality of user interaction event data that relates to a second common parameter.

By comparing groups of data more meaningful evaluation can be enabled.

Optionally, the first common parameter is a first user, and the second common parameter is a second user or a second parameter of users. Optionally, the first user and the second user(s) are in the same user category. Optionally, the first user and the second user(s) are in the same job type. Optionally, the first user and the second user(s) are in the same industry. Optionally, the first user and the second user(s) are in the same user group.

By comparing user-related groups of data particularly meaningful evaluation can be enabled. For example, alternatives to user-related groups of data such as object-related data groups, device-related data groups, and/or time period-related data groups may be evaluated.

Optionally, the reference user interaction event data comprises historical user interaction event data and/or live user interaction event data.

By combining historical and live data, meaningful insights can be generated close to real time.

Optionally, the reference user interaction event data comprises user interaction event data from the user and/or user interaction event data from users within the same organisation as the user, and/or user interaction event data from users from different organisations as the user.

By providing data from outside of the user's organisation, the size of the data pool available is increased.

Optionally, the proportion of user interaction event data from users within the same organisation as the user to user interaction event data from users from different organisations as the user is dependent on a quantity of user interaction event data from users within the same organisation.

Optionally, the proportion of user interaction event data from users within the same organisation as the user to user interaction event data from users from different organisations as the user is dependent on a number of employees in the user's organisation.

By adjusting the use of external data in proportion with the data available from within an organisation, the relevance of the data used is improved.

Optionally, evaluating user interactions based on the comparison of user interaction event data against a reference comprises identifying a behavioural scenario.

By providing behavioural scenarios, certain patterns of user behaviour can be more effectively identified and classified.

Optionally, the one or more monitored computer systems are one or more computer networks. Optionally, the one or more monitored computer systems are one or more computer devices.

By allowing the monitoring method to be used broadly, the utility of the monitoring method is increased.

Optionally, the reference is a probabilistic model of expected user interactions from said stored user interaction event data.

By testing against a probabilistic model large sets of data can be taken into account and compared, which can give a good reference for comparison.

Optionally, the method further comprises updating the probabilistic model of expected user interactions from said stored user interaction event data.

Updating the model in this way can enable the inclusion of further information into the probabilistic model for better accuracy.

Optionally, the probabilistic model is a trained artificial neural network.

A trained artificial neural network can accommodate particularly large amounts of data without excessive computational effort. Artificial neural networks can be adaptive based on incoming data and can be pre-trained, or trained on an on-going basis, to evaluate user behaviours.

Optionally, the probabilistic model is a continuous time model.

Continuous time analysis, as enabled by a continuous time model, can provide precise evaluation and can resolve small time differences without excessive computational effort.

Optionally, the user interaction event data is further tested against one or more predetermined models developed from previously identified user interaction scenarios.

The use of predetermined models as well as the probabilistic model can provide an additional way to evaluate user behaviour inside the monitored computer network, for example allowing particular scenarios to be detected.

Optionally, identifying from the metadata events corresponding to a plurality of user interactions with the monitored computer networks comprises: extracting relevant parameters from computer and/or network device metadata; and mapping said relevant parameters to a common data schema.

Mapping relevant parameters from metadata, for example log files, to or into a common data schema and format can make it possible for this normalised data to be compared more efficiently and/or faster.

Optionally, said common data schema comprises: data identifying an action performed in an event; and data identifying a user involved in an event and/or data identifying a device and/or application involved in an event.

By providing interaction event data according to such a common data schema, automated generation of statements that are sensible and human-readable can be enabled. Organising data originating from metadata into a set of standardised database fields, for example into subject, verb, and object fields in a database, can allow data to be processed efficiently subsequently in terms of discrete events, and such a data structure can also allow associations to be made earlier between specific ‘subjects’ (such as users), ‘verbs’ (such as actions), and/or ‘objects’ (such as devices and/or applications), improving the usability of the data available.

Optionally, said common data schema further comprises any or a combination of: data related to the or a user involved in an event; data related to the or an action performed in an event; and/or data related to the or a device and/or application involved in an event.

By providing interaction event data according to such a common data schema, more detailed information can be provided and can enable flexibility as to the information that can be accommodated in the common data schemata.

Optionally, identifying from the metadata events corresponding to a plurality of user interactions with the monitored computer networks comprises identifying additional parameters related to the metadata.

Additional data can enhance or increase the amount of data available about a particular event.

Optionally, the method further comprises storing contextual data, wherein said contextual data is related to a user interaction event.

Contextual data can be stored for later use to provide situational insights and assumptions that would not be apparent from the metadata, such as log files, alone. In particular, the contextual data stored can be that determined to be relevant by human and organisational psychology principles, which in turn may be used to explain or contextualise detected behaviours, which can assist to more accurately evaluate behaviour.

Optionally, the user interaction event data is further tested against one or more predetermined models developed from heuristics related to the contextual data.

The use of heuristics, for example predetermined heuristics based on psychological principles or insights, can allow for factors that may not be easily quantifiable to be taken into greater account, which can improve recognition of scenarios that may indicate particular behaviour.

Optionally, user interaction event data and/or contextual data are stored in a graph database.

The use of a graph database can allow for stored data to be updated and modified efficiently and can specifically allow for improved efficiency when storing or querying of relationships between events or other data.

Optionally, metadata and/or the relevant parameters therefrom are stored in an index database.

Storing primary data such as the metadata, for example raw logs and/or extracted parameters, can be useful for auditing purposes and allowing checks to be made against any outputs.

Optionally, the method further comprises reporting user interaction event data compared against the reference.

This can enable user access to the outcome of the evaluation.

Optionally, receiving metadata comprises aggregating metadata at a single entry point.

The use of a single entry point to any system implementing the method minimises the potential for unauthorised users or third parties tampering with metadata such as log files and lowers latency associated with transmission of metadata, which can improve the time taken to process the metadata.

Optionally, metadata is received at the device via one or more of a third party server instance, a client server within one or more computer networks, or a direct link with the one or more devices.

Using any of, a combination of or all of a third party server instance, a client server within one or more computer networks, or a direct link with the one or more devices allows for a variety of different types of metadata to be used, while minimising time associated with metadata transmission.

Optionally, metadata is extracted from one or more monitored computer networks via one or more of: an application programming interface, a stream from a file server, manual export, application proxy systems, active directory log-in systems, and/or physical data storage.

Using any of, a combination of or all of an application programming interface, a stream from a file server, manual export, application proxy systems, active directory log-in systems, and/or physical data storage again allows for a variety of different types of metadata to be used.

Optionally, the method further comprises determining whether two or more user interactions are part of an identifiable sequence of user interactions.

Identifying chains of user behaviour may assist in putting events in context, allowing for improved insights about user behaviour to be made.

According to a second aspect, there is provided apparatus for monitoring user interactions within one or more monitored computer networks, comprising: a metadata-ingesting module configured to receive and aggregate metadata from one or more devices within the one or more monitored computer networks; a data pipeline module configured to identify from the metadata events corresponding to a plurality of user interactions with the monitored computer networks; a data store configured to store user interaction event data from the identified said events corresponding to a plurality of user interactions with the monitored computer networks; and an analysis module to determine, using the stored user interaction event data, normal user interaction behaviour and store the determined normal user interaction behaviour as a reference.

Optionally, the analysis module is further arranged to compare user interaction event data against a reference to evaluate user interactions.

Apparatus can be provided that can be located within a computer network or system, or which can be provided in a distributed configuration between multiple related computer networks or systems in communication with one another, or alternatively can be provided at another location and in communication with the computer network or system to be monitored, for example in a data centre, virtual system, distributed system or cloud system.

Optionally, the apparatus further comprises a user interface accessible via a web portal and/or mobile application.

The user interface may be used to: view metrics, graphs and reports related to evaluated user interactions, query the data store, and/or provide feedback regarding evaluated user interactions. Providing a user interface can allow for improved interaction with the operation of the apparatus by relevant personnel along with more efficient monitoring of any outputs from the apparatus.

Optionally, the apparatus further comprises a transfer module configured to aggregate and send at least a portion of the metadata from the one or more devices within the one or more monitored computer networks, wherein the transfer module is within the one or more monitored computer networks.

Providing a transfer module allows for many types of metadata (which are not already directly transmitted to the metadata-ingesting module) to be quickly and easily collated and transmitted to the metadata-ingesting module.

According to an aspect, there is provided a method for monitoring user interactions within one or more monitored computer networks, comprising the steps of: receiving metadata from one or more devices within the one or more monitored computer networks; identifying from the metadata events corresponding to a plurality of user interactions with the monitored computer networks; storing user interaction event data from the identified said events corresponding to a plurality of user interactions with the monitored computer networks; and comparing user interaction event data against a reference to evaluate user interactions.

By comparing event data obtained from metadata in order to evaluate user interactions, a non-intrusive means of monitoring can be provided. Metadata from different sources may be pooled to enable effective and wide-reaching evaluation. The use of metadata related to user interactions (as encapsulated in log files, for example, which are typically already generated by devices and/or applications) means that data related to human interaction events can be obtained without needing to provide means to inspect and/or monitor the substantive content of user interactions with the system or data flowing within the system, which may be intrusive and difficult to set-up due to the volume of data that would then need to be processed. The term ‘metadata’ as used herein can refer to log data and/or log metadata.

Optionally, a sequence of user interaction events is identified and compared against said reference where the reference is a sequence of events.

By comparing sequences of events, more meaningful evaluation can be enabled.

Optionally, the time between user interaction events in the sequence is compared against the time between events in the reference sequence.

By comparing the times between events in sequences, particularly meaningful evaluation can be enabled.

Optionally, the reference is reference user interaction event data. By using user interaction event data as the reference the comparison between different groups can be enabled.

Optionally, the user interaction event data relates to a first common parameter and the reference is a second plurality of user interaction event data that relates to a second common parameter.

By comparing groups of data more meaningful evaluation can be enabled.

Optionally, the first common parameter is a first user, and the second common parameter is a second user.

By comparing user-related groups of data particularly meaningful evaluation can be enabled. For example, alternatives to user-related groups of data such as object-related data groups, device-related data groups, and/or time period-related data groups may be evaluated.

Optionally, the reference is a probabilistic model of expected user interactions from said stored user interaction event data.

By testing against a probabilistic model large sets of data can be taken into account and compared, which can give a good reference for comparison.

Optionally, the method further comprises updating the probabilistic model of expected user interactions from said stored user interaction event data.

Updating the model in this way can enable the inclusion of further information into the probabilistic model for better accuracy.

Optionally, the probabilistic model is a trained artificial neural network.

A trained artificial neural network can accommodate particularly large amounts of data without excessive computational effort. Artificial neural networks can be adaptive based on incoming data and can be pre-trained, or trained on an on-going basis, to evaluate user behaviours.

Optionally, the probabilistic model is a continuous time model.

Continuous time analysis, as enabled by a continuous time model, can provide precise evaluation and can resolve small time differences without excessive computational effort.

Optionally, the user interaction event data is further tested against one or more predetermined models developed from previously identified user interaction scenarios.

The use of predetermined models as well as the probabilistic model can provide an additional way to evaluate user behaviour inside the monitored computer network, for example allowing particular scenarios to be detected.

Optionally, identifying from the metadata events corresponding to a plurality of user interactions with the monitored computer networks comprises: extracting relevant parameters from computer and/or network device metadata; and mapping said relevant parameters to a common data schema.

Mapping relevant parameters from metadata, for example log files, to or into a common data schema and format can make it possible for this normalised data to be compared more efficiently and/or faster.

Optionally, said common data schema comprises: data identifying an action performed in an event; and data identifying a user involved in an event and/or data identifying a device and/or application involved in an event.

By providing interaction event data according to such a common data schema, automated generation of statements that are sensible and human-readable can be enabled. Organising data originating from metadata into a set of standardised database fields, for example into subject, verb, and object fields in a database, can allow data to be processed efficiently subsequently in terms of discrete events, and such a data structure can also allow associations to be made earlier between specific ‘subjects’ (such as users), ‘verbs’ (such as actions), and/or ‘objects’ (such as devices and/or applications), improving the usability of the data available.

Optionally, said common data schema further comprises any or a combination of: data related to the or a user involved in an event; data related to the or an action performed in an event; and/or data related to the or a device and/or application involved in an event.

By providing interaction event data according to such a common data, schema more detailed information can be provided and can enable flexibility as to the information that can be accommodated in the common data schemata.

Optionally, identifying from the metadata events corresponding to a plurality of user interactions with the monitored computer networks comprises identifying additional parameters related to the metadata.

Additional data can enhance or increase the amount of data available about a particular event.

Optionally, the method further comprises storing contextual data, wherein said contextual data is related to a user interaction event.

Contextual data can be stored for later use to provide situational insights and assumptions that would not be apparent from the metadata, such as log files, alone. In particular, the contextual data stored can be that determined to be relevant by human and organisational psychology principles, which in turn may be used to explain or contextualise detected behaviours, which can assist to more accurately evaluate behaviour.

Optionally, the user interaction event data is further tested against one or more predetermined models developed from heuristics related to the contextual data.

The use of heuristics, for example predetermined heuristics based on psychological principles or insights, can allow for factors that may not be easily quantifiable to be taken into greater account, which can improve recognition of scenarios that may indicate particular behaviour.

Optionally, user interaction event data and/or contextual data are stored in a graph database.

The use of a graph database can allow for stored data to be updated and modified efficiently and can specifically allow for improved efficiency when storing or querying of relationships between events or other data.

Optionally, metadata and/or the relevant parameters therefrom are stored in an index database.

Storing primary data such as the metadata, for example raw logs and/or extracted parameters, can be useful for auditing purposes and allowing checks to be made against any outputs.

Optionally, the method further comprises reporting user interaction event data compared against the reference.

This can enable user access to the outcome of the evaluation.

Optionally, receiving metadata comprises aggregating metadata at a single entry point.

The use of a single entry point to any system implementing the method minimises the potential for unauthorised users or third parties tampering with metadata such as log files and lowers latency associated with transmission of metadata, which can improve the time taken to process the metadata.

Optionally, metadata is received at the device via one or more of a third party server instance, a client server within one or more computer networks, or a direct link with the one or more devices.

Using any of, a combination of or all of a third party server instance, a client server within one or more computer networks, or a direct link with the one or more devices allows for a variety of different types of metadata to be used, while minimising time associated with metadata transmission.

Optionally, metadata is extracted from one or more monitored computer networks via one or more of: an application programming interface, a stream from a file server, manual export, application proxy systems, active directory log-in systems, and/or physical data storage.

Using any of, a combination of or all of an application programming interface, a stream from a file server, manual export, application proxy systems, active directory log-in systems, and/or physical data storage again allows for a variety of different types of metadata to be used.

Optionally, the method further comprises determining whether two or more user interactions are part of an identifiable sequence of user interactions.

Identifying chains of user behaviour may assist in putting events in context, allowing for improved insights about user behaviour to be made.

According to a further aspect, there is provided apparatus for monitoring user interactions within one or more monitored computer networks, comprising: a metadata-ingesting module configured to receive and aggregate metadata from one or more devices within the one or more monitored computer networks; a data pipeline module configured to identify from the metadata events corresponding to a plurality of user interactions with the monitored computer networks; a data store configured to store user interaction event data from the identified said events corresponding to a plurality of user interactions with the monitored computer networks; and an analysis module arranged to compare user interaction event data against a reference to evaluate user interactions.

Apparatus can be provided that can be located within a computer network or system, or which can be provided in a distributed configuration between multiple related computer networks or systems in communication with one another, or alternatively can be provided at another location and in communication with the computer network or system to be monitored, for example in a data centre, virtual system, distributed system or cloud system.

Optionally, the apparatus further comprises a user interface accessible via a web portal and/or mobile application.

The user interface may be used to: view metrics, graphs and reports related to evaluated user interactions, query the data store, and/or provide feedback regarding evaluated user interactions. Providing a user interface can allow for improved interaction with the operation of the apparatus by relevant personnel along with more efficient monitoring of any outputs from the apparatus.

Optionally, the apparatus further comprises a transfer module configured to aggregate and send at least a portion of the metadata from the one or more devices within the one or more monitored computer networks, wherein the transfer module is within the one or more monitored computer networks.

Providing a transfer module allows for many types of metadata (which are not already directly transmitted to the metadata-ingesting module) to be quickly and easily collated and transmitted to the metadata-ingesting module.

The aspects can extend to computer program products comprising software code for carrying out any method as herein described.

The aspects can also extend to methods and/or apparatus substantially as herein described and/or as illustrated with reference to the accompanying drawings.

The invention extends to any novel aspects or features described and/or illustrated herein.

Any apparatus feature as described herein may also be provided as a method feature, and vice versa. As used herein, means plus function features may be expressed alternatively in terms of their corresponding structure, such as a suitably programmed processor and associated memory.

Any feature in one aspect may be applied to other aspects, in any appropriate combination. In particular, method aspects may be applied to apparatus aspects, and vice versa. Furthermore, any, some and/or all features in one aspect can be applied to any, some and/or all features in any other aspect, in any appropriate combination.

It should also be appreciated that particular combinations of the various features described and defined in any aspects can be implemented and/or supplied and/or used independently.

The term ‘server’ as used herein should be taken to include local physical servers and public or private cloud servers, or applications running server instances.

The term ‘event’ as used herein should be taken to mean a discrete and detectable user interaction with a system.

The term ‘user’ as used herein should be taken to mean a human interacting with various devices and/or applications within or interacting with a client system, rather than the user of the monitoring system, which is denoted herein by the term ‘operator’.

The term ‘behaviour’ as used herein may be taken to refer to a series of events performed by a user.

### BRIEF DESCRIPTION OF THE DRAWINGS

Embodiments will now be described, by way of example only and with reference to the accompanying drawings having like-reference numerals, in which:

FIG. 1 shows a schematic illustration of the structure of a network including a security system;

FIG. 2 shows a schematic illustration of log file aggregation in the network of FIG. 1;

FIG. 3 shows a flow chart illustrating the log normalisation process in a monitoring system;

FIG. 4 shows a schematic diagram of data flows in the monitoring system;

FIG. 5 shows a flow chart illustrating the operation of an analysis engine in the monitoring system; and

FIG. 6 shows an exemplary evaluation report produced by the monitoring system.

### SPECIFIC DESCRIPTION

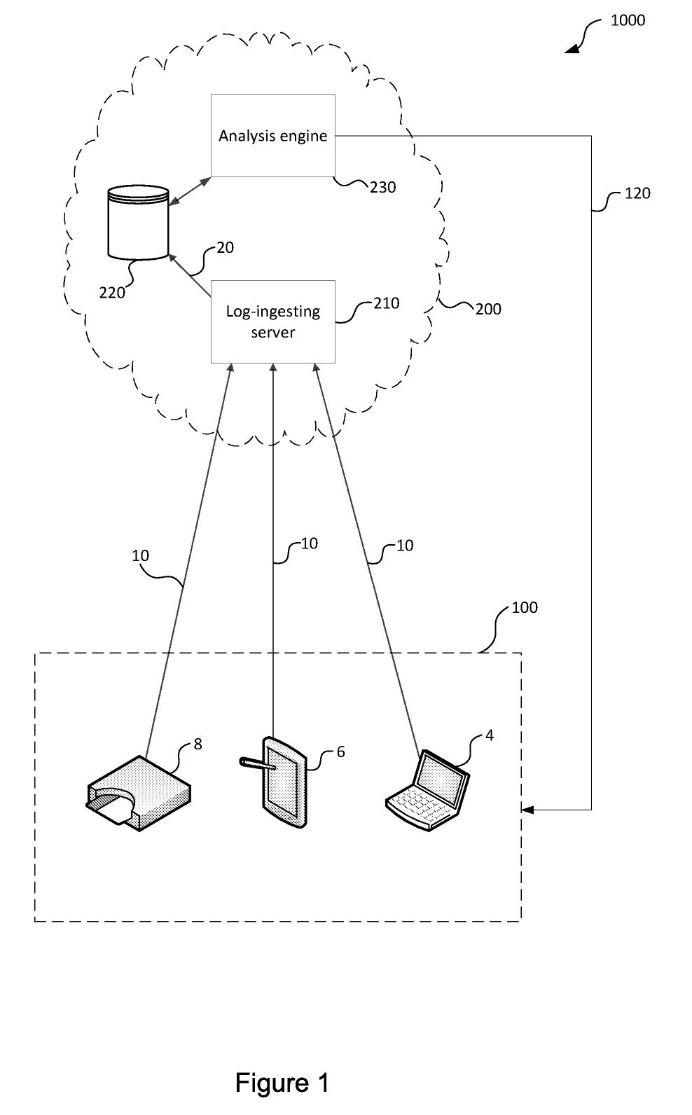

FIG. 1 shows a schematic illustration of the structure of a network 1000 including a security system according to an embodiment.

The network 1000 comprises a client system 100 and a monitoring system 200. The client system 100 is in an example a corporate IT system or network, in which there is communication with and between a variety of user devices 4, 6, such as one or more laptop computer devices 4 and one or more mobile devices 6. These devices 4, 6 may be configured to use a variety of software applications which may, for example, include communication systems, applications, web browsers, and word processors, among many other examples.

Other devices (not shown) that may be present on the client system 100 can include servers, data storage systems, door access systems, lifts, communication devices such as ‘phones and videoconference and desktop workstations among other devices capable of communicating via a network.

The network may include any of a wired network or wireless network infrastructure, including Ethernet-based computer networking protocols and wireless 802.11x or Bluetooth computer networking protocols, among others.

Other types of computer network or system can be used in other embodiments, including but not limited to mesh networks or mobile data networks or virtual and/or distributed networks provided across different physical networks.

The client system 100 can also include networked physical authentication devices, such as one or more key card or RFID door locks 8, and may include other “smart” devices such as electronic windows, centrally managed central heating systems, biometric authentication systems, or other sensors which measure changes in the physical environment.

All devices 4, 6, 8 and applications hosted upon the devices 4, 6, 8 will be referred to generically as “data sources” for the purposes of this description.

As users interact with the client system 100 using one or more devices 4, 6, 8, metadata relating to these interactions will be generated by the devices 4, 6, 8 and by any network infrastructure used by those devices 4, 6, 8, for example any servers and network switches. The metadata generated by these interactions will differ depending on the application and which the device 4, 6, 8 is used.

For example, where a user places a telephone call using a device 8, the generated metadata may include information such as the phone numbers of the parties to the call, the serial numbers of the device or devices used, and the time and duration of the call, the cost of the call, the geographical location of the parties to the call (as determined by the telephone numbers and/or IP addresses of the parties), among other possible types of information such as bandwidth of the call data and, if the call is a voice over internet call, the points in the network through which the call data was routed as well as the ultimate destination for the call data. Metadata is typically saved in a log file 10 that is unique to the device and the application, providing a record of user interactions. The log file 10 may be saved to local memory on the device 8 or a local or cloud server, or pushed or pulled to a local or cloud server, or both. If for example, the telephone call uses the network to place a voice over internet call, log files 10 will also be saved by the network infrastructure used to connect the users to establish a call as well as any data required to make the call that was requested from or transmitted to a server, for example a server providing billing services, address book functions or network address lookup services for other users of a voice over internet service.

In the network 1000, the log files 10 are exported to the monitoring system 200. It will be appreciated that the log files 10 may be exported via an intermediary entity (which may be within or outside the client system 100) rather than being exported directly from devices 4, 6, 8, as shown in the Figure.

The monitoring system 200 comprises a log-ingesting server 210, a data store 220 (which may comprise a number of databases with different properties so as to better suit various types of data, such as an index database 222 (for example, Elastic Search) and a graph database 224, for example, a relational database, a document NoSQL database (e.g. MongoDB) or other databases), and an analysis engine 230.

The log-ingesting server 210 acts to aggregate received log files 10, which originate from the client system 100. Typically the log files 10 will originate from the variety of devices 4, 6, 8 within the client system 100 and so can have a wide variety of formats and parameters. The log-ingesting server 210 then exports the received log files 10 to the data store 220, where they are processed into normalised log files 20. The analysis engine 230 compares the normalised log files 20 (providing a measure of present user interactions) to data previously saved in the data store (providing a measure of historic user interactions) and evaluates the normalised log files 20. Additionally, the detected interactions may be tested against various predetermined or trained scenarios. Reports 120 of user activity may then be reported back to the client system 100, to a specific user or group of users or as a report document saved on a server or document share on the client system 100.

The monitoring system 200, using the above process, is operable to determine normal behaviour for a single user or for a group of users in the course of their interactions with the clients system 100, which may be quantitatively determined using a plurality of parameters (for example, productivity, number and duration of breaks taken, or interactions with other users). In an example, the monitoring system 200 also monitors changes in the behaviour of a single user or a group of users away from determined normal behaviour. Such changes in behaviour may come about in response to, for example, a policy change or training. New users may change their behaviour as they learn and progress. The ‘normal behaviour’ of users (such as new users) may be updated accordingly as their typical interactions with the client system 100 change over time. Furthermore the behaviour of a particular user or a user group can be evaluated to identify behaviour that might be particularly beneficial. Once beneficial behaviour is identified it can be encouraged appropriately. For example, behaviour that characterises high performers might be identified. Similarly, detrimental behaviour can be identified, so as to allow remedial activities to be appropriately directed. Monitoring changes or differences in user behaviour can be advantageous for organisation optimisation and process performance optimisation. The monitoring and analysis can be undertaken at the level of individual users, or groups of users.

Further, the monitoring system 200 is arranged to determine whether a user falls into a certain behavioural scenario based on their detected behaviour. For example, if a user's performance changes or their engagement drops, this may indicate that a user has a low morale, is tired, depressed, burning out, or is about to resign.

It will be appreciated that the monitoring system 200 does not require the substantive content, i.e. the raw data generated by the user, of a user's interaction with a system as an input. Instead, the monitoring system 200 uses only metadata relating to the user's interactions, which is typically already gathered by devices 4, 6, 8 on the client system 100. This approach may have the benefit of helping to assuage or prevent any confidentiality and user privacy concerns. Furthermore the metadata is typically generated and available without any further effort on the part of the user, and so can provide an easily ready source of data.

The monitoring system 200 operates independently from the client system 100, and, as long as it is able to normalise each log file 10 received from a device 4, 6, 8 on the client system 100, the monitoring system 200 may be used with many client systems 100 with relatively little bespoke configuration. The monitoring system 200 may be cloud-based, providing for greater flexibility and improved resource usage and scalability.

The monitoring system 200 can be used in a way that is not network intrusive, and does not require physical installation into a local area network or into network adapters. This is advantageous for both security and for ease of set-up, but requires that log files 10 are imported into the system 200 either manually or exported from the client system 100 in real-time or near real-time or in batches at certain time intervals.

Examples of metadata, logging metadata, or log files 10 (these terms can be used interchangeably), include security audit logs created as standard by cloud hosting or infrastructure providers for compliance and forensic monitoring providers. Similar logging metadata or log files are created by many standard on-premises systems, such as SharePoint, Microsoft Exchange, and many security information and event management (SIEM) services. File system logs recording discrete events, such as logons or operations on files, may also be used and these file system logs may be accessible from physically maintained servers or directory services, such as those using Windows Active Directory. Log files 10 may also comprise logs of discrete activities for some applications, such as email clients, gateways or servers, which may, for example, supply information about the identity of the sender of an email and the time at which the email was sent, along with other properties of the email (such as the presence of any attachments and data size). Logs compiled by machine operating systems may also be used, such as Windows event logs, for example as found on desktop computers and laptop computers. Non-standard log files 10, for example those assembled by ‘smart’ devices (as part of an “internet of things” infrastructure, for example) may also be used, typically by collecting them from the platform to which they are synchronised (which may be a cloud platform) rather than, or as well as, direct collection from the device. It will be appreciated that a variety of other kinds of logs can be used in the monitoring system 200.

The log files 10 listed above typically comprise data in a structured format, such as extensible mark-up language (XML), JavaScript object notation (JSON), or comma-separated values (CSV), but may also comprise data in an unstructured format, such as the syslog format for example. Unstructured data may require additional processing, such as natural language processing, in order to define a schema to allow further processing.

The log files 10 may comprise data related to a user (such as an identifier or a name), the associated device or application, a location, an IP address, an event type, parameters related to an event, time, and/or duration. It will, however, be appreciated that log files 10 may vary substantially and so may comprise substantially different data between types of log file 10.

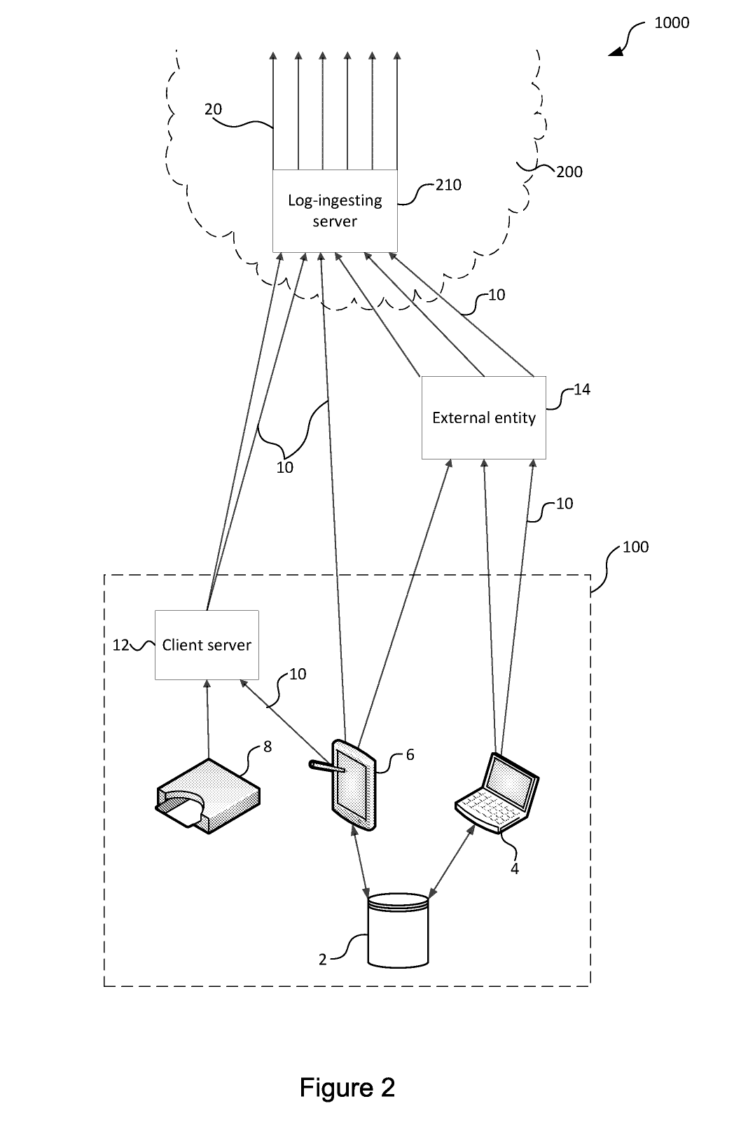

FIG. 2 shows a schematic illustration of log file 10 aggregation in the network 1000 of FIG. 1. As shown in FIG. 2, multiple log files 10 are taken from single devices 4, 6, 8, because each user may use a plurality of applications on each device, thus generating multiple log files 10 per device.

Some devices 4, 6 may also access a data store 2 (which may store secure data, for example), in some embodiments, so log files 10 can be acquired from the data store 2 by the monitoring system 200 directly or via another device 4, 6.

The log files 10 used are preferably transmitted to the log-ingesting server as close to the time that they are created as possible in order to minimise latency and improve the responsiveness of the monitoring system 200. This also serves to reduce the potential for any tampering with the log files 10 by unauthorised third parties, for example to excise log data relating to an unauthorised action within the client system 100 from any log files 10. For some devices, applications or services, a ‘live’ transmission can be configured to continuously transmit one or more data streams of log data to the monitoring system 200 as data is generated. Technical constraints, however, may necessitate that exports of log data occur only at set intervals for some or all devices or applications, transferring batches of log data or log files for the intervening interval since the last log data or log file was transmitted to the monitoring system 200.

Log data 10 may be transmitted by one or more means (which will be described later on) from a central client server 12 which receives log data 10 from various devices. This may avoid the effort and impracticality of installing client software on every single device. Alternatively, client software may be installed on individual workstations if needed. Client systems 100 may comprise SIEM (security information and event management) systems which gather logs from devices and end-user laptops/phones/tablets, etc.

For some devices such as key cards 8 and sensors, the data may be made available by the data sources themselves, as well as by the relevant client servers 12 (e.g. telephony server, card access server) that collect data.

In some cases, one or more log files 10 may be transmitted to or generated by an external entity 14 (such as a third party server) prior to transmission to the monitoring system 200. This external entity 14 may be, for example, a cloud hosting provider, such as SharePoint Online, Office 365, Dropbox, or Google Drive, or a cloud infrastructure provider such as Amazon AWS, Google App Engine, or Azure.

Log files 10 may be transmitted from a client server 12, external entity 14, or device 4, 6, 8 to the log-ingesting server 210 by a variety of means and routes including:
1. an application programming interface (API) for example arranged to push log data to the log-ingesting server 210, or arranged such that log data can be pulled to the log-ingesting server 210, at regular intervals or in response to new log data. Log data 10 may be collected automatically in real time or near-real time as long as the appropriate permissions are in place to allow transfer of this log metadata 10 from the client network 100 to the monitoring system 200. These permissions may, for example, be based on the OAuth standard. Log files 10 may be transmitted to the log-ingesting server 210 directly from a device 4, 6, 8 using a variety of communication protocols. This is typically not possible for sources of log files 10 such as on-premises systems and/or physical sources, which require alternative solutions.
2. file server streams where a physical file is being created. A software-based transfer agent installed inside the client system 100 may be used in this regard. This transfer agent may be used to aggregate log data 10 from many different sources within the client network 100 and securely stream or export the log files 10 or log data 10 to the log-ingesting server 210. This process may involve storing the collected log files 10 and/or log data 10 into one or more log files 10 at regular intervals, whereupon the one or more log files 10 is transmitted to the monitoring system 200. The use of a transfer agent can allow for quasi-live transmission, with a delay of approximately 1 ms-30 s.
3. manual export by an administrator or individual users via a transfer agent.
4. intermediary systems (e.g. application proxy, active directory login systems, or SIEM systems)
5. physical data storage means such as a thumb drive or hard disk or optical disk can be used to transfer data in some cases, for example, where data might be too big to send over slow network connections (e.g. a large volume of historical data).

The log files 10 enter the system via the log-ingesting server 210. The log-ingesting server 210 aggregates all relevant log files 10 at a single point and forwards them on to be transformed into normalised log files 20. This central aggregation (with devices 4, 6, 8 independently interacting with the log-ingesting server 210) reduces the potential for log data being modified by an unauthorised user or changed to remove, add or amend metadata, and preserves the potential for later integrity checks to be made against raw log files 10.

A normalisation process is then used to transform the log files 10 (which may be in various different formats) into generic normalised metadata or log files 20. The normalisation process operates by modelling any human interaction with the client system 100 by breaking it down into discrete events. These events are identified from the content of the log files 10. A schema for each data source used in the network 1000 is defined so that any log file 10 from a known data source in the network 1000 has an identifiable structure, and ‘events’ and other associated parameters (which may, for example, be metadata related to the events) may be easily identified and be transposed into the schema for the normalised log files 20.

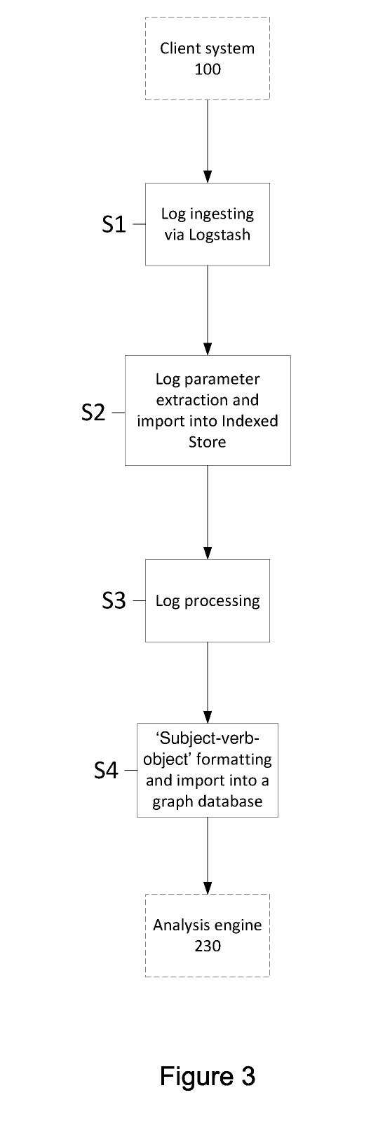

FIG. 3 shows a flow chart illustrating the log normalisation process in a monitoring system 200. The operation may be described as follows (with an accompanying example):

Stage 1 (S1). Log files 10 are received at the log-ingesting server 210 from the client system 100 and are parsed using centralised logging software, such as the Elasticsearch BV “Logstash” software. The centralised logging software can process the log files from multiple hosts/sources to a single destination file storage area in what is termed a “pipeline” process. A pipeline process provides for an efficient, low latency and flexible normalisation process.

An example line of a log file 10 that might be used in the security processing system 200 and parsed at this stage (S1) may be similar to the following:

L,08/08/12:14:36:02,00D70000000IiIT,00570000001IJJB,204.14.239.208,/ , , , “Mo zilla/5.0 (Windows NT 6.1; WOW64) AppleWebKit/536.11 (KHTML, like Gecko) Chrome/20.0.1132.57 Safari/536.11” , , ,

The above example is a line from a log file 10 created by the well-known Salesforce platform, in Salesforce's bespoke event log file format. This example metadata extract records a user authentication, or “log in” event.

Stage 2 (S2). Parameters may then be extracted from the log files 10 using the known schema for the log data from each data source. Regular expressions or the centralised logging software may be used to extract the parameters, although it will be appreciated that a variety of methods may be used to extract parameters. The extracted parameters may then be saved in the index database 222 prior to further processing. Alternatively, or additionally, the parsed log files 10 may also be archived at this stage into the data store 220. In the example shown, the following parameters may be extracted (the precise format shown is merely exemplary):

```
{
      “logRecordType”: “Login”,
      “DateTime”: “08/08/12:14:36:02”,
      “organizationId”: “00D70000000lilT”,
      “userId”: “00570000001IJJB”,
      “IP”: “10.228.68.70”,
      “URI”: “/”,
      “URI Info”: “”,
      “Search Query”: “”,
      “entities”: “”,
      “browserType”: “Mozilla/5.0 (Windows NT 6.1; WOW64)
      AppleWebKit/536.11 (KHTML: like Gecko) Chrome/20.0.1132.57
      Safari/536.11”,
      “clientName”: “”,
      “requestMethod”: “”,
      “methodName”: “”,
      “Dashboard Running User”: “”,
      “msg”: “”,
      “entityName”: “”,
      “rowsProcessed”: “”,
      “Exported Report Metadata”: “”
}
```

Stage 3 (S3). The system 200 may then look up additional data 40 in the data store 220, which may be associated with the user or IDs in the data above, for example, and use the additional data to add new parameters where possible and/or expand or enhance the existing parameters. The new set of parameters or enhanced parameters may then be saved in the index database 222. The additional data 40 may be initialised by a one-time setup for a particular client system 100. The additional data 40 might be also or alternatively be updated directly from directory services such as Windows Active Directory. When new additional data 40 becomes available, previous records can be updated as well with the new additional data 40. The additional data 40 can enable, for example, recognition of two users from two different systems as actually being the same user (“johndoe” on SalesForce is actually “jd” on the local network and “jdoe01©domain.tld” on a separate email system).The same principle applies at a file basis, rather than a user basis: additional data 40 can enable recognition of two data files from different systems as actually being the same file (“summary.docx” on the local server is the same document as “ForBob.docx” on Dropbox).

In the example previously described, the newly processed parameters may be shown as (with new data in bold):

```
{
      “logRecordType”: “Login”,
      “DateTime”: “08/08/12:14:36:02”,
      “organizationId”: “ACME Corp Ltd”,
      “userId”: “jdoe12”,
      “userFirstName”: “Jonathan”,
      “userLastName”: “Doe”,
      “IP”: “204.14.239.208”,
      “location”: {
            “country”: “US”,
            “state”: “CA”,
            “city”: “San Francisco”
      },
      “URI”: “/”,
      “URI Info”: “”,
      “Search Query”: “”,
      “entities”: “”,
      “browserType”:  “Mozilla/5.0  (Windows  NT  6.1;
      WOW64) AppleWebKit/536.11  (KHTML:  like  Gecko)
      Chrome/20.0.1132.57 Safari/536.11”,
      “browser”: “Chrome 20”,
      “OS”: “Windows 7”,
      “clientName”: “”,
      “requestMethod”: “”,
      “methodName”: “”,
      “Dashboard Running User”: “”,
      “msg”: “”,
      “entityName”: “”,
      “rowsProcessed”: “”,
      “Exported Report Metadata”: “”
}
```

Stage 4 (S4). To improve later analysis of user interaction with the client system 100 it is necessary to clearly identify events in ‘subject-verb-object’ format, rather than using a set of parameters related to an event as produced by steps S1-S3. At this processing stage the system 200 acts to identify ‘subject-verb-object’ combinations from the processed log data—where a ‘subject’ may comprise data relating to a user and related attributes, a ‘verb’ comprises data related to a particular action or activity together with related attributes, and an ‘object’ comprises data related to a target entity (such as a device or application) together with related attributes.

Arranging relevant data from the example event in a normalised ‘subject-verb-object’ format might take the following form (shown in a table):

| | Subject | Verb | Object |
|---|---|---|---|
| | jdoe12 | login | Salesforce |
| time | | 8th August | |
| | | 12:14:36.02 | |
| userFirstName | Jonathan | | |
| userLastName | Doe | | |
| organisation | Acme Corp Ltd | | |
| location | US/CA/San | | |
| | Francisco | | |
| browser | Chrome 20 | | |
| OS | Windows 7 | | |

In another example, a log may specify: TeamX AdministratorY removed UserZ from GroupT. This can convert into multiple “sentences”: “AdministratorY removed (from GroupT) UserZ” or “UserZ was removed (by AdministratorY) from GroupT”. These statements convey the same information but with various subjects. Typically the schema for ‘subject-verb-object’ combinations is configured on a per log type basis, but a certain degree of automation is possible. Industry standard fields like emails, userid, active directory, date/time etc. can be automatically recognised due to applications following norms and international standards. Implicitly, this means that a class of data sources can potentially have the same schema type and could be handled by simply defining a class schema (e.g. a ‘security information event management’ class schema).

The normalised data can then be formatted in a normalised log file 20 and saved in the graph database 224. The graph database 224 allows efficient queries to be performed on the relationships between data and allows for stored data to be updated, tagged or otherwise modified in a straightforward manner. The index database 222 may act primarily as a static data store in this case, with the graph database 224 able to request data from the index database 222 and use it to update or enhance the “graph” data in response to queries from the analysis engine 230. The ‘subject-verb-object’ format is represented in a graph database by two nodes (‘subject’ e.g. ‘AdministratorY’ and ‘object’ e.g. ‘UserZ’) with a connection (‘verb’ e.g. ‘remove’). Parameters are then added to all three entities (e.g. the “remove” action has parameters group and time).

Examples of index databases 22 that may be used include “mongoDB”, “elastic”, but also time series databases like InfluxDB, Druid and TSDB; an example of a graph database 224 that could be used is “neo4j”.

The databases making up the data store 220 are preferably non-SQL databases, which tend to be more flexible and easily scalable. It will be appreciated that the use of data related to log files from many distributed sources across a long time period means that the monitoring system 200 may store and process a very high volume of data.

The normalised log files 20 have a generic schema that may comprise a variety of parameters, which are preferably nested in the schema. The schema is optionally graph-based. The parameters included will vary to some extent based on the device and/or application that the log files 10 originate from, but the core ‘subject-verb-object’-related parameters are preferably consistent across normalised log files 20. Providing a unified generic schema for the normalised log files 20 enables the same schema to be adapted to any source of metadata, including new data sources or new data formats, and allows it to be scaled up to include complex information parameters. The generic schema can be used for ‘incomplete’ data by setting fields as ‘null’. Optionally, these null fields may then be found by reference to additional data 40 or data related to other events. Additionally, the use of a generic schema for the normalised log files 20 and a definition of a schema for the log files originating from a particular data source means that the monitoring system 200 may be said to be system-agnostic, in that, as long as the client system 100 comprises devices 4, 6, 8 which produce log files 10 with a pre-identified schema, the monitoring system 200 can be used with many client systems 100 without further configuration.

It is important that the normalised log files 20 are synchronised as accurately as possible in order for each user interaction with different components/devices/services of the client system 100 to be compared, for example with the benefit of accurate representations of sequences of events. For many applications of the monitoring system 200, analysis of small time gaps between events may be an important factor in characterising user behaviour. All log files 10 used by the monitoring system 200 should therefore contain timestamp information, allowing the log files 10 to be placed in their proper relative context even when the delays between file generation and receipt at the log-ingesting server 220 differ. The log files 10 may, optionally, be time stamped/re-time stamped at the point of aggregation or at the point at which the normalisation processing occurs in order to compensate for errors in time stamping, for example.

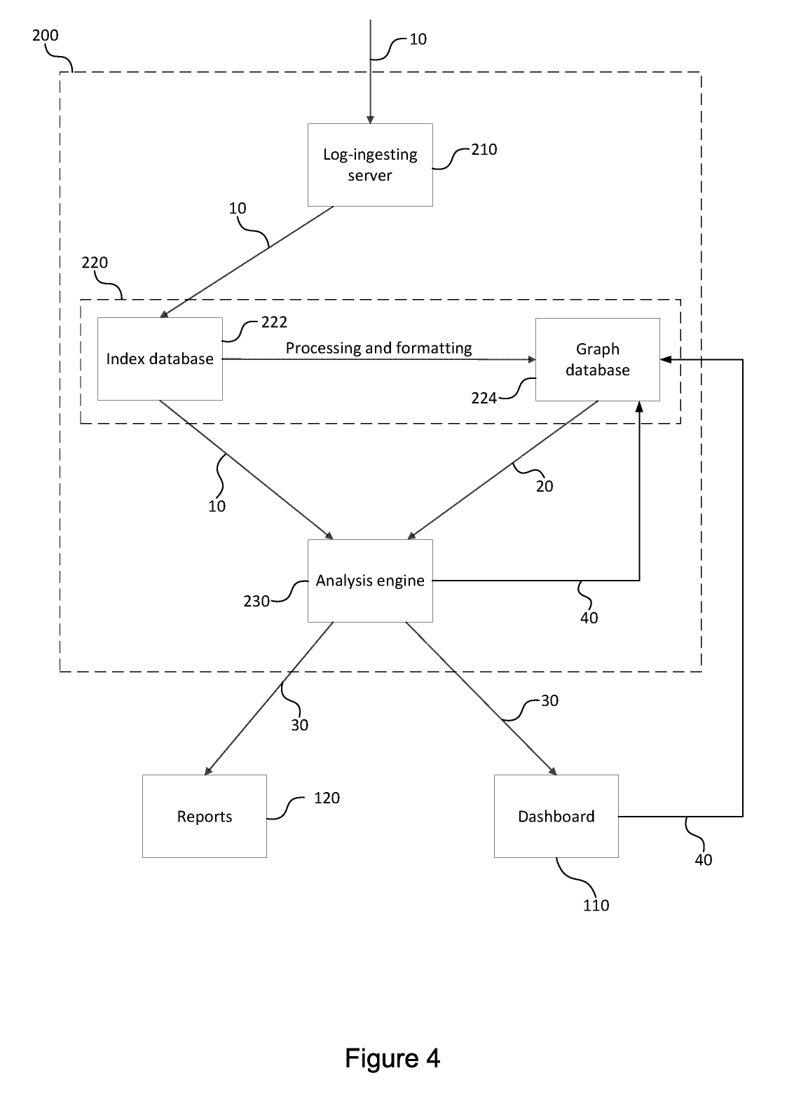

FIG. 4 shows a schematic diagram of data flows in the monitoring system 200. As shown, the analysis engine 230 may receive data (as normalised log files 20) from both the graph database 224 and, optionally, the index database 222, and may produce outputs 30 which may be presented to an administrator via reports 120 or on a ‘dashboard’ web portal or application 110. Outputs 30 may comprise an event or series of events compared to a reference. The outcome of the comparison may be classified based on one or more thresholds—so that an output 30 may be classified, for example, as ‘fast’, ‘average’, or ‘slow’. The thresholds used may be absolute thresholds, which are predetermined (by an operator, for example), or relative thresholds, which may relate to a percentage or standard deviation and so require that an exact value for the threshold is calculated on a per-event output 30 basis.

Additional contextual data and/or feedback 40 may be entered by an administrator (or other authorised) user using the dashboard 110 (which will be described later). This contextual data 40 is stored in the data store 220, optionally with the relevant data directly related to events. This contextual data 40 may be generated and saved by the analysis engine 230, as will be described later on, or may be manually input into the data store 220 by an administrator of the client system 100, for example. This contextual data 40 may be associated with a given user, device, application or activity, producing a ‘profile’ which is saved in the data store 220. The contextual data 40 may be based on cues that are largely or wholly non-quantitative, being based on human and organisational psychology. The use of this data 40 allows for complex human factors to be taken into account when assessing a user's normal behaviour or changes away from a user's normal behaviour, rather than relying on the event-by-event account supplied by collected log files 10. Contextual data 40 related to a user may comprise, for example, job role, working patterns, personality type, and risk rating (for example, a user who is an administrator may have a higher level of permissions within a client system 100, and so represent a high risk). The use of contextual data 40 allows users to be compared against other users in the same category (for example where categories are determined in relation to a specific parameter, such as ‘late workers’ and ‘early workers’) and/or job types. Other contextual data 40 may include the typical usage patterns of a workstation or user. Many other different factors can be included in this contextual data 40. The contextual data 40 includes psychology-related data that is integrated into the monitoring system 200 by modelling qualitative studies into chains of possible events/intentions with various probabilities based on parameters like age, gender, cultural background, role in the organisation, and personality type. The user's personality type may be determined using psychometric analysis, which is performed by some organisations in order to find potential leaders or just to know which person is preferred for which position, for example. Metrics such as ‘openness’ or ‘agreeableness’ can be determined and may be incorporated into the analysis engine 230, which can associate the psychological metrics to the observed behaviour.

Analysis based on continuous time (as opposed to discrete time) may be used to analyse probabilities with more accuracy. Continuous time may allow for millisecond/nanosecond differences between actions to be detected. For analysing sequences of events, the relative timing between actions (and not necessarily exact time of day) is important. By analysing the timeline of a sequence of events separated by small amounts of time, chains of actions (corresponding to complex behaviour) can be resolved. Because time is a continuous variable in the continuous time approach, the way questions are asked changes, as follows:
in discrete time, the analysis engine 230 would be able to compute the probability of a user performing an action in a time interval. The probability of this action being performed by the user is equal throughout that slot.
in continuous time, the analysis engine 230 may compute much more precisely exact values for different times, such as one millisecond apart.

In order to calculate values in continuous time, an appropriate model may use differential equations, interpolation and/or other continuous approximation functions.

The analysis engine 230 may comprise a plurality of algorithms packaged as individual modules. The modules are developed according to machine learning principles which are specialized in modelling a single or a subset of behavioural traits. The modules may be arranged to operate and/or learn on all data sources provided by the normalised log data, or a subset of the data sources. The analysis engine 230 may be arranged to extract certain parameters provided in the normalised log data and provide the parameters to the modules.

The individual modules can be any unsupervised or supervised algorithms, and may use one or more of a plurality of algorithms. The algorithms may incorporate one or more static rules, which may be defined by operator feedback. The algorithms may be based on any combination of simple statistical rules (such as medians, averages, and moving averages), density estimation methods (such as Gaussian mixture models, kernel density estimation), clustering based methods (such as density based, partitioning based, or statistical model based clustering methods, Bayesian clustering, or K-means clustering algorithms), and graph-based methods being arranged to detect social patterns (which may be referred to as social graph analysis), resource access activity, and/or resource importance and relevance (which may be referred to as collaborative filtering). The graph-based methods can be clustered and/or modelled over time. In addition, time series anomaly detection techniques may be used, such as change point statistics or WSARE algorithms (also known as “what's strange about recent events” algorithms). Although the algorithms may be unsupervised, they may be used in combination with supervised models such as neural networks. The supervised neural net may be trained to recognise patterns of events (based on examples, or feedback by the operator) which may indicate that the user is unexpectedly changing their behaviour or marks a long term in their normal behaviour (the saved data relating to a user's normal behaviour may then be updated accordingly). The algorithms as a whole may therefore be referred to as ‘supervised-unsupervised’.

Additionally, the analysis engine 230 comprises a higher layer probabilistic model providing a second layer of statistical learning, which is arranged to combine the outcomes of the individual modules and detect changes at a higher, more abstract, level. This may be used to identify abnormal and/or malicious human interactions with the client system 100. The second layer of statistical learning may be provided by clustering users based on the data produced by the individual modules. Changes in the clusters may be detected, and/or associations can be made between clusters. The change in the data produced by the individual modules may be modelled over time. The data produced by the individual modules may also be dynamically weighted, and/or the data produced by the individual modules may be predicted.

Optionally, the analysis engine 230 may be arranged to pre-process data to be used as an input for the modules. The pre-processing may comprise any of: aggregating or selecting data based on a location associated with the normalised log data or a time at which the data is received and/or generated, determining parameters (such as a ratio of two parameters provided as part of the normalised log data), performing time series modelling on certain parameters provided in the normalised log data (for example, using continuous models such as autoregressive integrated moving average (ARIMA) models and/or discrete models such as string-based action sequences). The pre-processing may be based on the output of one of more of the modules related to a particular parameter, how the output changes over time and/or historic data related to the output.

One of the main problems with machine learning systems is a paucity of data for training purposes; however, the high volume of data collected and saved by the monitoring system 200 means development of an effective algorithm for the analysis engine 230 is possible. If not enough data is available, for example, in the case where new employees join a business, data can be used from employees similar to the new employee based on role, department, behaviour, etc. as well as based on the pre-modelled psychological traits. A particular problem for the system 200 in relation to small organisations and to users having specialised roles (such as leadership roles) is that only a small data set is available. As such, data from external sources, such as data relating to different organisations or from different client systems 100, may be used so as to provide additional data for use in the system 200. For example, the contextual data 40 related to a particular user may comprise aggregated data related to typical user behaviour for users in similar roles in the same industry. This allows user's behaviour to be compared against normal behaviour for an industry, rather than just being compared against their peers within an organisation. The volume of contextual data 40 from external sources used in the analysis engine 230 may be dynamically adjusted depending on the volume of contextual data 40 available to the analysis engine 230. For example, as an organisation expands and more users in similar roles join the organisation, more contextual data 40 from within the organisation is available and so contextual data 40 from external sources may be used to a lesser extent.

Similarly, data from external sources can be used in specific ‘case studies’ of a particular scenario of user behaviour. For example, external data may be used as part of a model of a scenario, such as a user burning out or suffering from depression. Such data may be incorporated into training data for the analysis engine 230.

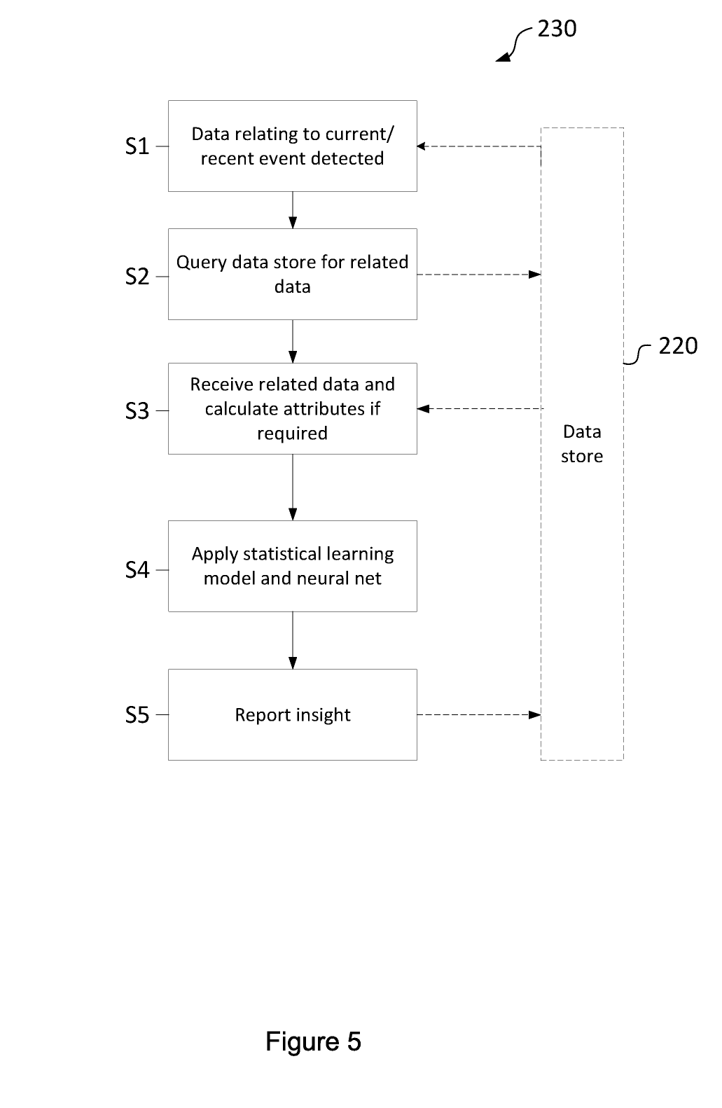

FIG. 5 shows a flow chart illustrating the operation of the analysis engine 230 in the monitoring system 200, where the analysis engine 230 is configured to compare and evaluate user behaviour. The operation may be described as follows:

Stage 1 (S1). The analysis engine 230 detects that information related to an event is available via the data store 220. This information may comprise normalised log files 20 which have been normalised and pushed into the data store 220 immediately before being detected by the analysis engine 230, but alternatively may relate to less recent data, as will be explained later.

Stage 2 (S2). The analysis engine 230 then may query the data store 220 for related data, in order to set the data relating to the event in context. This related data may comprise both data related to historic events and contextual data 40.

Stage 3 (S3). The related data is received. At this stage a number of attributes may be calculated based on the related data to assist in further processing. Alternatively, previously calculated attributes may be saved in the data store 220, in which case they are recalculated based on any new information. These attributes may relate to the user involved (such as attributes related to normal user behaviour), or may be static attributes related to the event or the object(s) involved in the event. User-related attributes may comprise distributions of activity types by time and/or location or a record of activity over a recent period (such as a 30 day sliding window average of user activity). Static attributes (or semi-static, and changing gradually over time) may comprise the typical number of machines used, the usual number of locations, devices used, browser preferences, and number of flagged events in the past.

Stage 4 (S4). The algorithms of the analysis engine 230 are then applied to the gathered data. Tests may be used to produce a score which may be compared against a number of thresholds in order to classify an event or series or events, as mentioned. An anomaly detection algorithm can find divergence between the tested event(s) and expected behaviour. A trained model is used to find the probability of the user to be active at the given time and performing the given activity—if it is found that the present event is significantly improbable, this may be a cause to flag the event as unusual.

The probability of a combination of events occurring, such as a chain of events, is tested alongside the probability of an individual event occurring. A score for a combination of events may be produced in a simple case simply by combining the per event scores. New events can be determined to be part of a chain of events by a number of processes, including probability calculations related to the probability that two events occur one after the other and/or probability calculations using continuous time analysis to analyse the time differences between sequential events. The length of the time differences between events in a chain of events is also incorporated into the anomaly detection algorithm. Multiple chains of events may occur simultaneously, such as when a user is multitasking. Multitasking behaviour can be determined by looking at the range of resources accessed by the user in a short time period (such as if the user is using two different browsers or making a phone call). Multitasking is a behaviour in itself, so this may be flagged and used in the analysis engine 230.

The analysis engine is operable to determine whether detected changes in user behaviour are a sudden, expected change, or are indicative of a gradual change in user behaviour. This may be determined by reference to earlier user behaviour and/or events.

Additionally the data may be tested using additional constraints from contextual data 40. As mentioned above, the analysis engine 230 may be trained based on a variety of different example scenarios. Events (or combinations of events) being analysed by the analysis engine 230 are tested against these scenarios using one or more of correlation, differential source analysis and likelihood calculations, which may be based on user or object history, type of action, events involving the user or object, or other events happening concurrently or close to the same time.

The analysis engine 230 may calculate a confidence score for the output 30. An operator decision may be fed back into the learning algorithm, causing various parameters to change so as to reduce the probability that a event is wrongly evaluated. This may comprise using an algorithm to update the parameters for all ‘neurons’ of the supervised neural net. Examples of approaches that could be used in this regard are AdaBoost, BackPropagation, and Ensemble Learning. The supervised neural net is thereby able to adapt based on feedback, improving the accuracy of outputs 30.

Stage 5 (S5). The results of the analysis engine's calculation and any outputs 30 produced may then be reported to an operator. The results and/or outputs 30 are also saved into the data store 220.

It will be appreciated that the steps described above are merely an exemplary representation of the operation of the analysis engine 230 according to an embodiment, and alternative processing may be used in other embodiments. In particular, the described steps may be performed out of the described order or simultaneously, at least in part in other embodiments.

Analyses may be made over several different time periods, and may be scheduled accordingly—for example, on demand or periodically in which case the analysis engine 230 may analyse data from the last 3 hours once an hour, data from the last 2 days once a day (such as overnight), data from the last month once a week, and so on. The analysis engine 230 may also analyse at least certain of the data and/or calculate at least certain outputs in near real time, for example, where an API or file transfer agent is used to transfer log files to the analysis engine 230 in near real time.

The monitoring system 200 is preferably arranged to act quickly to react quickly to changes in user behaviour. As such, the analysis engine 230 may act on data that has been collected immediately prior to being received by the analysis engine 230, and optionally also when the data originates from devices that send log files 10 as that are generated. However, many pre-excluded events are only identifiably pre-excluded in the context of many other events or over a relatively long time scale. In addition, some log files 10 are not sent ‘live’, meaning that many events cannot immediately be set in the context of other events if they are processed as soon as possible after being received by the log-ingesting server 210. In order to account for this data and to correctly find any suspicious ‘long timescale’ events, the analysis engine 230 is used to analyse collected data on a scheduled basis. This occurs in parallel with the analysis engine 230 being used to analyse ‘live’ data as described. Analyses may be made over several different time periods, and may be scheduled accordingly—for example, along with processing ‘live’ data, the analysis engine 230 may analyse data from the last 3 hours once an hour, data from the last 2 days once a day (such as overnight), data from the last month once a week, and so on. Some data might arrive with a delay (e.g. from scheduled or manually shipped logs) and its inclusion might impact the analysis. In order to take later arrived data into consideration, once the log-ingesting server 210 has ingested newly received delayed data, the combined (previously ingested) ‘live’ data and the newly received delayed data is replayed through the analysis engine 230. This way, changes in user behaviour can be flagged that were not previously identified due to lack of data. This replaying is done in parallel with the live detection until it reaches real-time.

In an example scenario of pre-excluded activity that the monitoring system 200 may be trained to recognise based on a psychological cue, there is typically a distinct and detectable time signature between certain events that is characteristic of a user. For example, this time signature may comprise the average time taken for a user to review a certain kind of document. If this time gradually decreases, it may be a sign that the user is becoming better at this task, or that they are becoming stressed. If these assumptions are true, neither would be cause for great concern. However, if a user suddenly begins to work much faster (as detected by the time signature) this may be a signal that they have suddenly become highly stressed. This may indicate that the user may have received bad news, or they may have been put under duress for example. Distinctive time differences between events which are detectable in certain situations such as that described above may be fed into the analysis engine 230 as input data together with other data related to historic events and contextual data 40.

Detected interactions with elements of one part of the client system 100 may be used by the analysis engine 230 in combination with detected interactions with other elements of the system 100 to produce sophisticated insights and/or to strengthen assumptions about user behaviour. For example, in relation to the example described above, if it is detected that the user is taking very long or very short breaks (using both data originating from applications used by the user and by keycard data, which may indicate the user's physical movements in an office) this may be used to strengthen the presumption that the user is stressed. Contextual data may also be useful in explaining scenarios—for example, the security provision system 200 is provided with contextual data relating to times and dates of performance reviews, the user's sudden onset of stress may be linked to an upcoming or recent performance review.

The association of a ‘profile’ for a given user, device, application or activity allows the analysis engine 230 to evaluate behaviour and/or changes away from normal behaviour at a high level of granularity, enabling the detection of for example users suddenly starting to do activities that they have never done. As mentioned, additional contextual data 40 may also be used in order that the analysis engine 230 can take account of non-quantitative factors and use them to bias insights about behaviour. For example, if a contextual data 40 such as a psychological profile is inputted, a user may be characterised as an extrovert. Alternatively, a user may be automatically classified as an extrovert based on factors relating to their outgoing communications to other users, for example. This may then change certain parameter limits for determining whether an activity is unusual. The monitoring system 200 may then be able to detect whether a user is behaving out of character—for example, if the extrovert in the example above begins working at unsociable times when none of his or her colleagues are in the office, this may be combined with the insights that they are performing poorly and that these behaviours are new and not normal (for that user) thus to infer that the user may require attention.

Other assumptions produced from contextual data 40 (such as a user's job) may include that, generally, certain employees (i.e. users) do not work regular hours, while one group of users with a certain role may tend to arrive at the office later than other users with another group of job types, and some individual employees tend to take long lunch breaks. A mix of generalisations can be compiled per job type (i.e. user groups), thus allowing for sudden changes of behaviour as compared to colleagues with the same job type to be easily detected. Distinctive time differences between events which are detectable in certain situations may be fed into the analysis engine 230 as input data together with other data related to historic events and contextual data 40.

The analysis engine 230 may be able to prioritise potentially unusual behaviours, changes in behaviour, and/or events based on the determined probability that the observed behaviour is abnormal behaviour or behaviour of interest. The evaluation may be supplemented with manually applied weightings (as additional contextual data 40) or may be made using weightings generated by the monitoring system 200 and automatically applied to various kinds of activities, users, or documents to assist in this prioritisation.

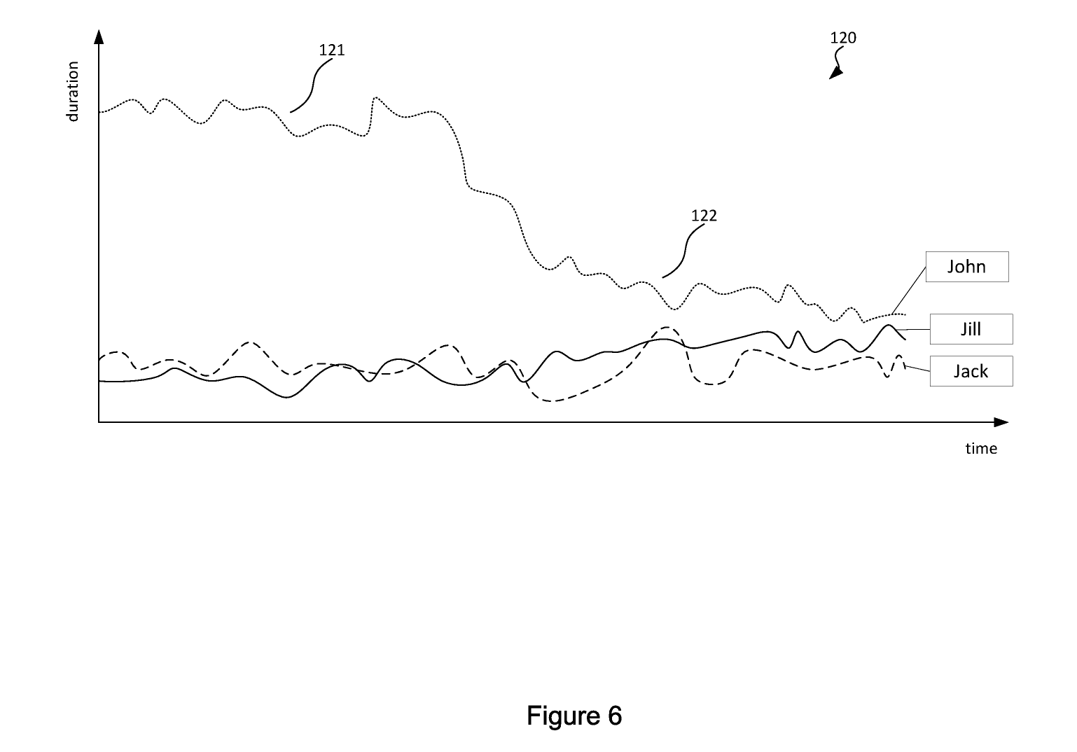

FIG. 6 shows an exemplary report 120 produced by the monitoring system 200. The report 120 shows a chart of the time duration of completing a particular task (such as: check out a document from a server; amend the document; and check it back into the server) for three employees ‘John’ ‘Jack’ and ‘Jill’. John was identified as being slower 121 than his colleagues in his normal behaviour, and was enrolled in a training course, following which the monitoring system 200 could detect that John became faster 122. The illustration shows a graph chart, but the report can present evaluation results in many other ways. The type of report can be tailored to the evaluation and the viewer's preferences. Reports can be provided on demand, or at regular intervals, or if a particular condition is fulfilled.

Optionally, the monitoring system 200 may interface with an online dashboard 110, which may be available through a web portal or a mobile application, which may show reports (as previously described) and allow live monitoring of the events detected in the log files 10. This dashboard 110 may comprise a map/location-based view showing all activity or on a map, graphs showing relationships between objects, tables and data around identified graphs, details about events and timelines of related events, for example relating to the same user(s) or object(s). The dashboard 110 may provide the ability for an administrator to explore objects, actions and users connected to events in a global context. The administrator may query the data store 220 using the dashboard. The dashboard 110 may also be used to set-up the monitoring system 200, such as by allowing the input of information.

Where a particular event (or combination of events) is detected as it is occurring, the monitoring system 200 may be able to issue an alert via email, SMS, phone call or virtual assistant or another communication means. The system 200, if appropriately configured, may also be able to automatically implement one or more as actions in response to a particular event or combination of events. This action may be configurable by the operator.

The thresholds at which these actions occur may be predetermined by the operator or may be dynamically determined based on operator preferences. In either case, the operator may be able to provide feedback about the action taken, which may be used to automatically adjust thresholds, thus improving the response of the system 200.

The monitoring system 200 may also be able to further process the normalised log files 20 to new logs of events in human-readable format, using the ‘subject-verb-object’ processing described earlier. These new logs can be combined so as to show a user's workflow in the client system 100, and may be produced to show a sequence of events over a certain time period or for a certain user. This feature may extend to the provision of a unified timeline of a user's actions, or of actions involving an object, incorporating a plurality of new logs of events sorted by time. It may also be used to provide a description of events in a report 120. The analysis of events in a timeline manner can have benefits for example for procedure improvements, personnel reviews, checks of work performed in highly regulated environments etc. Data can be expressed in a number of different ways depending on the detail required or available. With reference to the example described in relation to FIG. 3, this could include:

“Jonathan logged into Salesforce”

“Jonathan logged into Salesforce yesterday at 12:14”

“Jonathan logged into Salesforce yesterday at 12:14 from the Office”

“Jonathan logged into Salesforce yesterday at 12:14 from the Office using Chrome 20 on Windows 7”

The analysis engine 230 may be able to check the last log update from all or any data source, and recognise if latency has increased or if the system has failed.

As described above, a schema is manually defined for each data source to allow log files 10 form that data source to be processed. Alternatively, the functionality of the log-ingesting server 210 may extend to ingesting a file defining a schema for a specific data source, recognising it as such, and then automatically applying this schema to log files 10 received from, that data source.

The monitoring system 200 may be used in combination with or integrate security solutions, such as encryption systems and document storage systems.

Where data on a client system 100 is of the highest importance, such that cloud systems are not deemed to be sufficiently secure, a ‘local’ version of the monitoring system 200 may be used, in which the monitoring system 200 is integrated within the client system 100.

The monitoring system 200 could for example monitor the progress (in terms of speed between actions, for example) of new starters leaning how to interact with a company's system could be monitored and areas that may require special attention flagged. Alternatively, unusual behaviour can be investigated to identify other scenarios which may be undesirable—such as users who are about to resign, or who are engaging in illegal behaviour (such as downloading copyrighted content using the client system 100).

The client system 100 may be a single usual device, where the monitoring system 200 is used to monitor the user device rather than a network. The user device may be a computer such as a workstation, or a mobile device, for example. In such a case, the user's interactions with the device are monitored to determine user behaviour. The outputs of such a monitoring system may be use as an input for a further monitoring system 200 being arranged to monitor a wider client system 100 with which the user device can communicate.

It will be understood that the present invention has been described above purely by way of example, and modifications of detail can be made within the scope of the invention.

Each feature disclosed in the description, and (where appropriate) the claims and drawings may be provided independently or in any appropriate combination.

Reference numerals appearing in the claims are by way of illustration only and shall have no limiting effect on the scope of the claims.

1. A method of monitoring user interactions within one or more monitored computer systems, comprising the steps of:
receiving metadata from one or more devices within the one or more monitored computer systems;
identifying from the metadata events corresponding to a plurality of user interactions with the monitored computer systems;
storing user interaction event data from the identified said events corresponding to a plurality of user interactions with the monitored computer systems;
determining, using the stored user interaction event data, normal user interaction behaviour; and
storing the determined normal user interaction behaviour as a reference.

2. The method of claim 1, further comprising the step of comparing the identified user interaction event data against the reference to evaluate user interactions.

3. The method of claim 1 or 2, wherein a sequence of user interaction events is identified and compared against said reference where the reference is a sequence of events.

4. The method of claim 3, wherein the time between user interaction events in the sequence is compared against the time between events in the reference.

5. The method of any preceding claim, wherein the reference is reference user interaction event data.

6. The method of claim 5, wherein the user interaction event data relates to a first common parameter and the reference is a plurality of user interaction event data that relates to a second common parameter.

7. The method of claim 6, wherein the first common parameter is a first user, and the second common parameter is a second user or a second plurality of users.

8. The method of claim 7, wherein the first user and the second user(s) are in the same user category.

9. The method of claim 8, wherein the first user and the second user(s) are in the same job type.

10. The method of claim 8 or 9, wherein the first user and the second user(s) are in the same industry.

11. The method of any of claims 8 to 10, wherein the first user and the second user(s) are in the same user group.

12. The method of any of claims 5 to 11, wherein the reference user interaction event data comprises historical user interaction event data and/or live user interaction event data.

13. The method of any of claims 5 to 12, wherein the reference user interaction event data comprises user interaction event data from the user and/or user interaction event data from users within the same organisation as the user, and/or user interaction event data from users from different organisations as the user.

14. The method of claim 13, wherein the proportion of user interaction event data from users within the same organisation as the user to user interaction event data from users from different organisations as the user is dependent on a quantity of user interaction event data from users within the same organisation.

15. The method of claim 13 or 14, wherein the proportion of user interaction event data from users within the same organisation as the user to user interaction event data from users from different organisations as the user is dependent on a number of employees in the user's organisation.

16. The method of any preceding claim, wherein evaluating user interactions based on the comparison of user interaction event data against a reference comprises identifying a behavioural scenario.

17. The method of any preceding claim, wherein the one or more monitored computer systems are one or more computer networks.

18. The method of any preceding claim, wherein the one or more monitored computer systems are one or more computer devices.

19. The method of any preceding claim, wherein the reference is one or more probabilistic models of expected user interactions from said stored user interaction event data.

20. The method of claim 19, further comprising updating the probabilistic model(s) of expected user interactions from said stored user interaction event data.

21. The method of claim 19 or 20, wherein one or more of the probabilistic models are trained artificial neural networks.

22. The method of any of claims 19 to 21, wherein one or more of the probabilistic models are continuous time models.

23. The method of any of claims 19 to 22, wherein the user interaction event data is further tested against one or more predetermined models developed from previously identified user interaction scenarios.

24. The method of any preceding claim, wherein identifying from the metadata events corresponding to a plurality of user interactions with the monitored computer systems comprises:
extracting relevant parameters from computer and/or network device metadata; and
mapping said relevant parameters to a common data schema.

25. The method of any preceding claim, wherein identifying from the metadata events corresponding to a plurality of user interactions with the monitored computer systems comprises identifying additional parameters related to the metadata.

26. The method of any preceding claim, further comprising storing contextual data, wherein said contextual data is related to a user interaction event.

27. The method of claim 26, wherein the user interaction event data is further tested against one or more predetermined models developed from heuristics related to the contextual data.

28. The method of any preceding claim, wherein user interaction event data and, when dependent on claim 26 or 27, the contextual data are stored in a graph database.

29. The method of any preceding claim, wherein metadata and/or the relevant parameters therefrom are stored in an index database.

30. The method of any preceding claim, further comprising comparing user interaction event data against a reference to evaluate user interactions at a scheduled time and/or continuously.

31. The method of any preceding claim, further comprising reporting user interaction event data compared against the reference.

32. The method of any preceding claim, wherein receiving metadata comprises aggregating metadata at a single entry point.

33. The method of any preceding claim, wherein metadata is received at the device via one or more of a third party server instance, a client server within one or more computer networks, or a direct link with the one or more devices.

34. The method of any preceding claim, wherein metadata is extracted from one or more monitored computer systems via one or more of: an application programming interface, a stream from a file server, manual export, application proxy systems, active directory log-in systems, and/or physical data storage.

35. Apparatus for monitoring user interactions within one or more monitored computer systems, comprising:
a metadata-ingesting module configured to receive and aggregate metadata from one or more devices within the one or more monitored computer systems;
a data pipeline module configured to identify from the metadata events corresponding to a plurality of user interactions with the monitored computer systems;
a data store configured to store user interaction event data from the identified said events corresponding to a plurality of user interactions with the monitored computer systems; and
an analysis module arranged to determine, using the stored user interaction event data, normal user interaction behaviour and store the determined normal user interaction behaviour as a reference.

36. Apparatus according to claim 35, wherein the analysis module is further arranged to compare user interaction event data against the reference to evaluate user interactions.

37. Apparatus according to claim 35 or 36, further comprising a user interface accessible via a web portal and/or mobile application.

38. Apparatus according to claim 37, wherein the user interface may be used to: view metrics, graphs and reports related to identified user interactions, and/or query the data store.

39. Apparatus according to any of claims 35 to 38, further comprising a transfer module configured to aggregate and send at least a portion of the metadata from the one or more devices within the one or more monitored computer systems, wherein the transfer module is within the one or more monitored computer systems.

40. Apparatus for carrying out the method of any of claims 1 to 34.

41. A computer program product comprising software code for carrying out the method of any of claims 1 to 34.

42. A method for monitoring user interactions within one or more monitored computer networks, comprising the steps of:
receiving metadata from one or more devices within the one or more monitored computer networks;
identifying from the metadata events corresponding to a plurality of user interactions with the monitored computer networks;
storing user interaction event data from the identified said events corresponding to a plurality of user interactions with the monitored computer networks; and
comparing user interaction event data against a reference to evaluate user interactions.

43. The method of claim 42, wherein a sequence of user interaction events is identified and compared against said reference where the reference is a sequence of events.

44. The method of claim 43, wherein the time between user interaction events in the sequence is compared against the time between events in the reference.

45. The method of any of claims 42 to 44, wherein the reference is reference user interaction event data.

46. The method of claim 45, wherein the user interaction event data relates to a first common parameter and the reference is a plurality of user interaction event data that relates to a second common parameter.

47. The method of claim 46, wherein the first common parameter is a first user, and the second common parameter is a second user.

48. The method of any of claims 42 to 47, wherein the reference is a probabilistic model of expected user interactions from said stored user interaction event data.

49. The method of claim 48, further comprising updating the probabilistic model of expected user interactions from said stored user interaction event data.

50. The method of claim 48 or 49, wherein the probabilistic model is a trained artificial neural network.

51. The method of any of claims 48 to 50, wherein the probabilistic model is a continuous time model.

52. The method of any of claims 47 to 51, wherein the user interaction event data is further tested against one or more predetermined models developed from previously identified user interaction scenarios.

53. The method of any of claims 42 to 52, wherein identifying from the metadata events corresponding to a plurality of user interactions with the monitored computer networks comprises:
extracting relevant parameters from computer and/or network device metadata; and
mapping said relevant parameters to a common data schema.

54. The method of any of claims 42 to 53, wherein identifying from the metadata events corresponding to a plurality of user interactions with the monitored computer networks comprises identifying additional parameters related to the metadata.

55. The method of any of claims 42 to 54, further comprising storing contextual data, wherein said contextual data is related to a user interaction event.

56. The method of claim 55, wherein the user interaction event data is further tested against one or more predetermined models developed from heuristics related to the contextual data.

57. The method of any of claims 42 to 56, wherein user interaction event data and, when dependent on claim 55 or 56, the contextual data are stored in a graph database.

58. The method of any of claims 42 to 57, wherein metadata and/or the relevant parameters therefrom are stored in an index database.

59. The method of any of claims 42 to 58, further comprising reporting user interaction event data compared against the reference.

60. The method of any of claims 42 to 59, wherein receiving metadata comprises aggregating metadata at a single entry point.

61. The method of any of claims 42 to 60, wherein metadata is received at the device via one or more of a third party server instance, a client server within one or more computer networks, or a direct link with the one or more devices.

62. The method of any of claims 42 to 61, wherein metadata is extracted from one or more monitored computer networks via one or more of: an application programming interface, a stream from a file server, manual export, application proxy systems, active directory log-in systems, and/or physical data storage.

63. Apparatus for monitoring user interactions within one or more monitored computer networks, comprising:
a metadata-ingesting module configured to receive and aggregate metadata from one or more devices within the one or more monitored computer networks;
a data pipeline module configured to identify from the metadata events corresponding to a plurality of user interactions with the monitored computer networks;
a data store configured to store user interaction event data from the identified said events corresponding to a plurality of user interactions with the monitored computer networks; and
an analysis module arranged to compare user interaction event data against a reference to evaluate user interactions.

64. Apparatus according to claim 63, further comprising a user interface accessible via a web portal and/or mobile application.

65. Apparatus according to claim 64, wherein the user interface may be used to: view metrics, graphs and reports related to identified user interactions, and/or query the data store.

66. Apparatus according to any of claims 63 to 65, further comprising a transfer module configured to aggregate and send at least a portion of the metadata from the one or more devices within the one or more monitored computer networks, wherein the transfer module is within the one or more monitored computer networks.

67. Apparatus for carrying out the method of any of claims 42 to 62.

68. A computer program product comprising software code for carrying out the method of any of claims 42 to 62.

69. A method substantially as herein described and/or as illustrated with reference to the accompanying figures.

70. Apparatus substantially as herein described and/or as illustrated with reference to the accompanying figures.
